(19) United States
(12) Patent Application Publication
(10) Pub. No.: US 2023/0112198 A1
(43) Pub. Date: Apr. 13, 2023

(54) NOISE-RESISTANT ASSEMBLIES

(71) Applicant: 3M INNOVATIVE PROPERTIES COMPANY, St. Paul, MN (US)

(72) Inventors: Taewook Yoo, Stillwater, MN (US); Kim-Tong Gan, Troy, MI (US); Anja C. Rohmann, Schwalmtal (DE); Masato Kondo, Sagamihara-shi (JP); Hirokazu Mizutani, Tokyo (JP); Hyunjun Shin, San Jose, CA (US); Seungkyu Lee, Curentino, CA (US); Jonathan H. Alexander, Roseville, MN (US)

(21) Appl. No.: 17/958,992

(22) Filed: Oct. 3, 2022

Related U.S. Application Data
(60) Provisional application No. 63/253,719, filed on Oct. 8, 2021.

(51) Int. Cl. G10K 11/162; G10K 11/172

(52) U.S. Cl. CPC G10K 11/162; G10K 11/172

(57) ABSTRACT

Described herein are noise-resistant assemblies pursuant to various commercial and industrial applications. The noise-resistant assemblies can include duct assemblies, pool assemblies, motor assemblies, carpet flooring assemblies, and roofing assemblies. These assemblies incorporate an acoustic article containing a porous layer and a heterogeneous filler having a median particle size of from 1 micrometer to 1000 micrometers and a specific surface area of from 0.1 m²/g to 10,000 m²/g received in the porous layer.

### FIELD OF THE INVENTION

Provided are acoustic assemblies for mitigating noise in industrial and consumer applications.

### BACKGROUND

Noise pollution can profoundly affect user experience associated with the products we use. Excessively loud and inescapable sounds are known to cause hearing loss, stress, and high blood pressure and can have significant adverse effects on wildlife. Whether such noise arises from vehicles, manufacturing equipment, household products, ventilation systems, or water lines, it is highly desirable to reduce such impacts where possible.

Addressing noise can be a significant technical challenge. To improve fuel efficiency, automotive and aerospace manufacturers have replaced many heavy steel components with lighter weight materials, such as aluminum and plastic. Yet, as vehicular structures become lighter, noise tends to become increasingly difficult to attenuate because of the mass law. Based on the mass law, the sound insulation of a solid element generally increases by about 5 dB per doubling of mass. Thus, lighter materials are normally disadvantaged compared to heavier materials in mitigating noise.

Conventional acoustic absorber materials include felt, foam, fiberglass, and polyester materials. These materials are generally provided at higher thicknesses to be effective at absorbing airborne noise over a wide range of frequencies. This has the effect of making the absorbers bulky, which can reduce cabin space available to vehicle occupants.

### SUMMARY

To reduce noise, manufacturers have used various kinds of acoustic barriers and absorbers. These materials can either block transmission of noise or dissipate the sound energy by converting it into other forms of energy such as heat. Dense, viscous materials have properties that are ideal for acoustic absorbers, but also add significant weight to the vehicle. Further, the dimensional requirements for such materials can be significant. The performance of conventional acoustic absorbers can be estimated by comparing the size of the sound wave to the thickness of the absorber. To be effective in absorbing lower frequencies, these acoustic absorbers often have a thickness that is at least 10% of the wavelength of the incoming sound wave.

For some applications, this is a problem because there may be geometric and/or volumetric constraints imposed by the spaces where acoustic absorbers are to be installed. These constraints may be encountered, for example, when insulating aerospace or automotive vehicles. To maximize cabin space, it is generally desirable to absorb sound in as thin a construction as possible. Yet because of their long wavelength, low frequency noise tends to transmit easily through thin acoustic absorbers.

Certain porous and/or fine organic and inorganic particles demonstrate excellent absorption over a wide range of frequencies and can display synergistic acoustic properties when incorporated into certain porous layers. This behavior has been observed in both polymeric compositions and inorganic compositions such as clay particles, diatomaceous earth, plant-based filler, non-layered silicates, and unexpanded graphite. These porous and/or fine particles, when enmeshed into the interstices of a porous medium, can provide a very high surface area to volume ratio, enabling acoustic absorption at lower frequencies than otherwise possible. Such acoustic profile can be tuned through the combination of the particle characteristics and how it is rendered within the porous medium.

This profile is a product of the particle composition, surface area of the particle, and particle size. Particular combinations of these materials can provide a high level of acoustic absorption over both high and low frequencies in a thin, layered construction. This disclosure discloses particularly advantageous configurations enabling such materials to be deployed in various noise-generating consumer and industrial applications.

In a first aspect, a noise-resistant assembly is provided. The noise-resistant assembly comprises: a tubular body having an inner surface; and an acoustic article coupled to the inner surface, the acoustic article comprising a porous layer and a heterogeneous filler having a median particle size of from 1 micrometer to 1000 micrometers and a specific surface area of from 0.1 m²/g to 10,000 m²/g received in the porous layer.

In a second aspect, a noise-resistant assembly is provided, comprising: a pool housing having an inner and outer wall; and an acoustic article extending across the outer wall of the pool housing, the acoustic article comprising a porous layer and a heterogeneous filler having a median particle size of from 1 micrometer to 1000 micrometers and a specific surface area of from 0.1 m²/g to 10,000 m²/g received in the porous layer.

In a third aspect, a noise-resistant assembly is provided, comprising: a motor; and an acoustic article that at least partially encloses the motor, the acoustic article comprising a porous layer and a heterogeneous filler having a median particle size of from 1 micrometer to 1000 micrometers and a specific surface area of from 0.1 m²/g to 10,000 m²/g received in the porous layer.

In a fourth aspect, a noise-resistant assembly is provided, comprising: a carpet layer; and an acoustic article extending across the carpet layer, the acoustic article comprising a porous layer and a heterogeneous filler having a median particle size of from 1 micrometer to 1000 micrometers and a specific surface area of from 0.1 m²/g to 10,000 m²/g received in the porous layer.

In a fifth aspect, a noise-resistant assembly is provided, comprising: a glazing; a spacer layer disposed on the glazing that provides a gap therebetween; and an acoustic article extending across the spacer layer, the acoustic article comprising a porous layer and a heterogeneous filler having a median particle size of from 1 micrometer to 1000 micrometers and a specific surface area of from 0.1 m²/g to 10,000 m²/g received in the porous layer.

### BRIEF DESCRIPTION OF THE DRAWINGS

FIGS. 1 and 2 are cross-sectional views of a noise-resistant duct assembly;

FIG. 3A is an isometric view of a noise-resistant vehicular shade for an automotive vehicle;

FIG. 3B is a cross-sectional view of the noise-resistant vehicular shade of FIG. 3A;

FIG. 4 is a cross-sectional view of a noise-resistant pool assembly;

FIGS. 5 and 6 are isometric views showing the construction of a noise-resistant motor housing assembly;

FIG. 7 is a photograph showing a motor assembly incorporating a noise-resistant motor housing assembly;

FIG. 8 is a cross-sectional view of a noise-resistant carpet flooring assembly;

FIG. 9 is a cross-sectional view of an alternative noise-resistant housing assembly for a motor.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### Definitions

As used herein:

“Average” means number average, unless otherwise specified.

“Copolymer” refers to polymers made from repeat units of two or more different polymers and includes random, block and star (e.g. dendritic) copolymers.

“Die” means a processing assembly including at least one orifice for use in polymer melt processing and fiber extrusion processes, including but not limited to melt-blowing.

“Discontinuous” when used with respect to a fiber or plurality of fibers means fibers having a limited aspect ratio (e.g., a ratio of length to diameter of e.g., less than 10,000).

“Enmeshed” means that particles are dispersed and physically and/or adhesively held in the fibers of the web.

“Median fiber diameter” of fibers in a non-woven fibrous layer is determined by producing one or more images of the fiber structure, such as by using a scanning electron microscope; measuring the transverse dimension of clearly visible fibers in the one or more images resulting in a total number of fiber diameters; and calculating the median fiber diameter based on that total number of fiber diameters.

“Non-woven fibrous layer” means a plurality of fibers characterized by entanglement or point bonding of the fibers to form a sheet or mat exhibiting a structure of individual fibers or filaments which are interlaid, but not in an identifiable manner as in a knitted fabric.

“Particle” refers to a small distinct piece or individual part of a material (i.e., a primary particle) or aggregate thereof in finely divided form. Primary particles can include flakes, powders and fibers, and may clump, physically intermesh, electrostatically associate, or otherwise associate to form aggregates. In certain instances, particles in the form of aggregates of individual particles may be formed as described in U.S. Pat. No. 5,332,426 (Tang et al).

“Polymer” means a relatively high molecular weight material having a molecular weight of at least 10,000 g/mol.

“Porous” means containing holes or voids.

“Size” refers to the longest dimension of a given object or surface.

“Substantially” means a majority of, or mostly, as in an amount of at least 50%, 60, 70, 80, 90, 95, 96, 97, 98, 99, 99.5, 99.9, 99.99, or 99.999%, or 100%.

### DETAILED DESCRIPTION

As used herein, the terms “preferred” and “preferably” refer to embodiments described herein that can afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises” and variations thereof do not have a limiting meaning where these terms appear in the accompanying description. Moreover, “a,” “an,” “the,” “at least one,” and “one or more” are used interchangeably herein. Relative terms such as left, right, forward, rearward, top, bottom, side, upper, lower, horizontal, vertical, and the like may be used herein and, if so, are from the perspective observed in the particular figure. These terms are used only to simplify the description, however, and not to limit the scope of the invention in any way.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention.

The present disclosure is directed to acoustic articles, assemblies, and methods thereof that function as acoustic absorbers, vibration dampers, and/or acoustic and thermal insulators. The acoustic articles and assemblies generally include one or more porous layers and one or more heterogeneous fillers in contact with the one or more porous layers. Optionally, the provided acoustic articles and assemblies include one or more non-porous barrier layers, resonators, and/or air gaps adjacent to the one or more porous layers. Structural and functional characteristics of each of these components are described in the subsections that follow.

### Noise-Resistant Assemblies

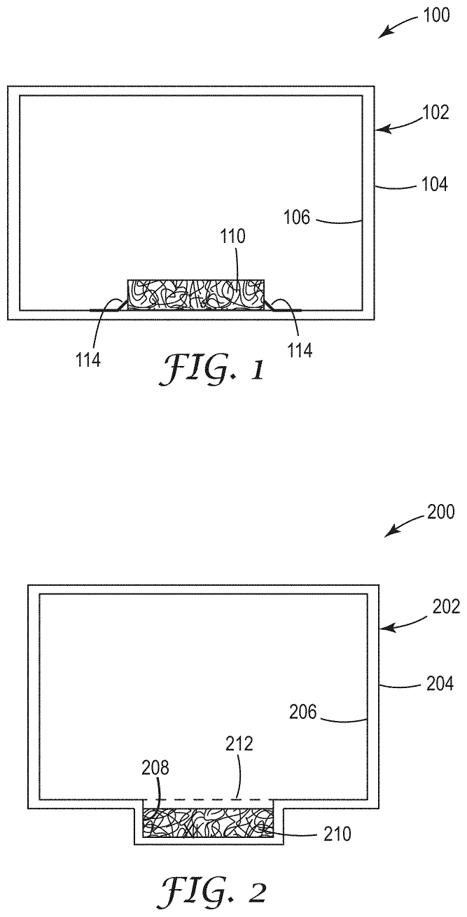

Exemplary noise-resistant assemblies directed to various consumer and industrial applications are illustrated in FIGS. 1-9 and described below.

FIG. 1 shows the cross-section of a duct assembly having a sound-absorbing capability according to one exemplary embodiment, which is hereinafter designated by the numeral 100. The duct assembly 100 includes a tubular body 102 having an outer surface 104 and inner surface 106. The inner surface 106 circumscribes a passage for flow of a fluid, typically air or some other gas. Coupled to the inner surface 106 is an acoustic article 110 capable of dissipating acoustic noise and/or vibration.

The acoustic article 110, details of which are described in a forthcoming section, is shown here having a rectangular cross-section, but can have any suitable size and shape to facilitate coupling to the inner surface 106 of the tubular body 102. In this configuration, the acoustic article 110 is secured to the inner surface 106 by ultrasonic welds 114. In alternative embodiments, the acoustic article 110 can be coupled to the inner surface 106 of the tubular body 102 using a pressure-sensitive adhesive, flowable adhesive, thermal welding, mechanical fastener, undercut structures, or any other coupling mechanism.

The presence of the acoustic article 110 within the fluid flow passage enables the duct assembly 100 to significantly reduce noise generated by cooling fans and air flow noise, as is often encountered in automotive climate control applications.

FIG. 2 shows a duct assembly 200 according to an alternative embodiment. Like duct assembly 100, the duct assembly 200 includes a tubular body 202 having an outer surface 204 and an inner surface 206. Unlike the prior example, however, the inner surface 206 further includes a cavity 208, where an acoustic article 210 is received in the cavity 208. In some embodiments, the acoustic article 210 can have a size and shape substantially matching the cavity 208 to maximize use of space and help secure the acoustic article 210 within the cavity 108 in vehicular applications, where vibrations and sudden acceleration and deceleration might occur. Disposing the acoustic article 210 in the cavity 208 can help streamline fluid flow through the duct assembly 200 and reduce turbulence.

Optionally and as shown in FIG. 2, the acoustic article 210 is further secured within the cavity 208 by a cover layer 212 extending across the opening of the cavity 208. The cover layer 212 is not particularly restricted and can be made from any solid or porous film capable of being coupled to the inner surface 206. In alternative embodiments, the acoustic article 210 is coupled to the inner surface 206 of the tubular body 202 using an adhesive, thermal or ultrasonic welding, mechanical fastener, or other physical coupling. Use of a porous cover layer 212 can further facilitate fluid flow while preserving communication between the fluid and the acoustic article 210, enhancing acoustic absorption.

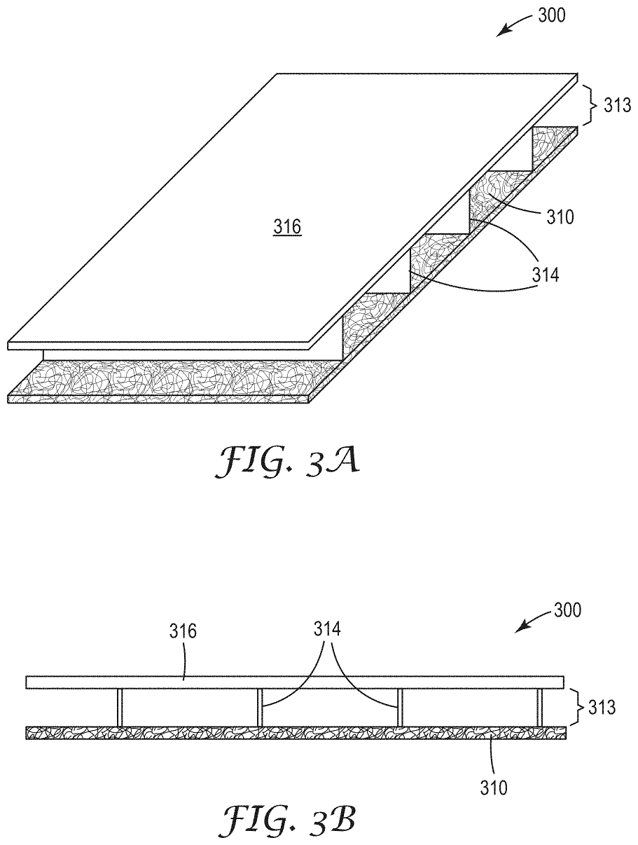

FIGS. 3A and 3B illustrate a vehicular shade 300 viewed from two different angles. The vehicular shade 300 has a layered construction comprised of an acoustic article 310, a spacer layer 313 coupled to the acoustic article 310, and a roof panel 316 coupled to the spacer layer 313. The spacer layer 313 provides a gap between the roof panel 316 and the acoustic article 310, and is in this instance comprised of a set of parallel walls 314. Optionally but not shown, the vehicular shade 300 can include a second set of parallel walls extending along a different direction and intersecting with the walls 314.

As shown, each of the plurality of walls 314 is generally perpendicular to both the neighboring acoustic article 310 and roof panel 316. Optionally and as shown, each of the acoustic article 310, plurality of walls 314, and roof panel 316 has individually a planar configuration. The walls 314 of the vehicular shade 300 partition the gap between the roof panel 316 and acoustic article 310 into compartments, or air chambers. When properly tuned, these air chambers can act as a multiplicity of local resonant cavities that can be tuned to dissipate noise having certain targeted frequencies.

In an advantageous embodiment, the roof panel 316 is a glazing, such as provided on the roof of a car. If the roof panel 316 is a glazing, the walls 314 and acoustic article 310 of the vehicular shade 300 can be translated, in a sliding manner, relative to the roof panel 316 to enable an occupant of the vehicle to extend or retract the shading feature. In this instance, the walls 314 and acoustic article 310 can be coupled to each other and both can be slidably engaged to the roof panel 316 along a groove or track to facilitate sliding movement. In other applications, the roof panel 316 can be an opaque vehicular panel made of steel or aluminum.

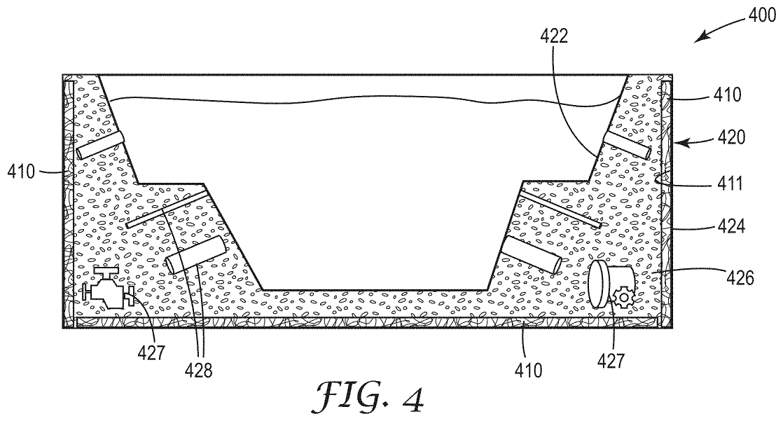

FIG. 4 shows a noise-resistant assembly embodied in the form of a consumer whirlpool or hot tub. Hot tub 400 includes a pool housing 420, which is in turn comprised of a basin 422, an outer wall 424, and insulation material 426. Disposed in the space between the basin 422 and the outer wall 424 are acoustic articles 410. Provided within the insulation material 426 are noise-generating devices 427. Such devices 427 may include, but are not limited to, pumps and motors. The insulation material 426 further includes openings 428 for plumbing and air lines for operative connection to these devices 427. The openings 428 can extend through the acoustic articles 410 in certain locations where needed.

Here, the acoustic articles 410 assume the form of rectilinear panels coupled to an inner surface 411 of the outer wall 424, but again these can be provided in any appropriate shape or size. In some embodiments, and as shown here, the acoustic articles 410 are generally aligned along the outer wall 424 and the insulation material 426 could also be wrapped beneath the basin 422 or be embedded within the insulation material 426.

Thickness of insulation material 426 can vary depending on the volume of the basin. In some instances, it can be desirable to initially cover larger areas by attaching with clips or glue with adhesive. It can be beneficial to avoiding leakages to avoid noise paths as well as thermal gaps. The thickness of insulation material 426 can range from 5 mm up to 50 mm, or in some embodiments, less than, equal to, or greater than 5 mm, 10, 15, 20, 25, 30, 35, 40, 45, or 50 mm, depending on space available. The material can be attached by clips, mechanical fasteners or an adhesive. Alternatively, the insulation material 426 can be attached directly on the pool tub in order to achieve an acoustical absorption and noise reduction by additional damping and reduced transmission loss as well as an additional thermal insulation. Coverage along the outer wall can help reduce the noise by acoustical absorption. Advantageously, acoustical absorption and thermal insulation could be achieved at the same time.

While not explicitly shown here, it is also possible for an acoustic article 410 to completely fill the open space between the basin 422 and the outer wall 424. In this embodiment, the insulation material 426 depicted in FIG. 4 is essentially replaced by the composition of the acoustic articles 410. This can afford the benefit of further improving the overall acoustic absorption of the noise resistant assembly.

As exemplified by the hot tub 400, incorporation of acoustic articles can be useful in outdoor portable swimming pools, free standing whirlpools, spas, and similar products. In general, these pools are equipped with pumps, jets or filter machinery which can produce significant noise pollution. To minimize this noise, insulation is necessary. It is common for noise sources, such as pumps, to be installed within the pool housing or in a separate housing external to the hot tub, so inclusion of the acoustic articles 410 can significantly reduce noise while adding little weight and occupying minimal space within the pool housing 420.

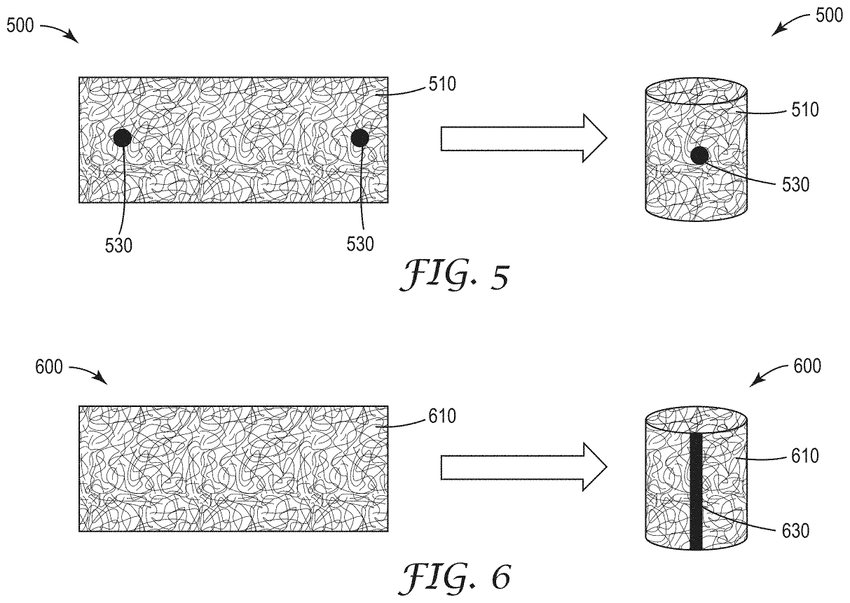

FIGS. 5-7 show a noise-resistant motor cover, which can be used for example to reduce motor noise in electric vehicles. As shown in FIG. 5, a motor cover 500 is comprised of an acoustic article 510 provided in the form of a flexible planar strip. The flexible planar strip can be coupled to itself using one or more fasteners 530 to form an enclosure, within which an electric motor (not shown) can be received to provide a motor assembly. Useful fasteners are not particularly restricted and can include buttons, screws, hook-and-loop attachment surfaces, staples, clips, bales, and the like. For some applications, it can be beneficial to use mating fasteners 530 that can be reversibly attached to and detached from each other.

FIG. 6 shows a variant of the prior embodiment represented as motor cover 600, which includes an acoustic article 610 but does not require any fasteners. The acoustic article 610 is wrapped into a tubular configuration as before, but then secured to itself by an ultrasonic weld 630, whereby the acoustic article 610 can at least partially enclose a motor (not shown) to provide a motor assembly. Other ways of securing the acoustic article 610 in a like manner are possible, such as by thermal welding or use of an adhesive.

The acoustic articles 510, 610 can have any suitable thickness to achieve the desired acoustic function for the targeted application. Useful minimum thicknesses for the acoustic articles 510, 610 can be from 5 millimeters to 12 millimeters, or in some embodiments, less than, equal to, or greater than, 5 millimeters, 6, 7, 8, 9, 10, 11, or 12 millimeters.

FIG. 7 shows a photograph of a prototype of a noise-resistant cover, in which the acoustic article is fastened to itself using a mating button assembly. This noise resistant cover could be at least partially enclose, for example, a cylindrical motor assembly.

FIG. 8 shows a multilayered noise-resistant carpet assembly 700 having a carpet layer 732 and an acoustic article 710 extending across the carpet layer 732. In this application, the acoustic article 710 can provide sound absorbency as well as a noise barrier function. The thickness of the carpet assembly 700 can range from 5 mm up to 12 mm, or in some embodiments, less than, equal to, or greater than 5 mm, 6, 7, 8, 9, 10, 11, or 12 mm, depending on the space available. In an alternative embodiment, but not shown, the acoustic article could be used with deck board or other flooring materials. In actual use, the carpet assembly 700 was found to improve sound absorption performance relative to conventional carpet underlayment, especially at medium sound frequencies (e.g., at 800 Hz).

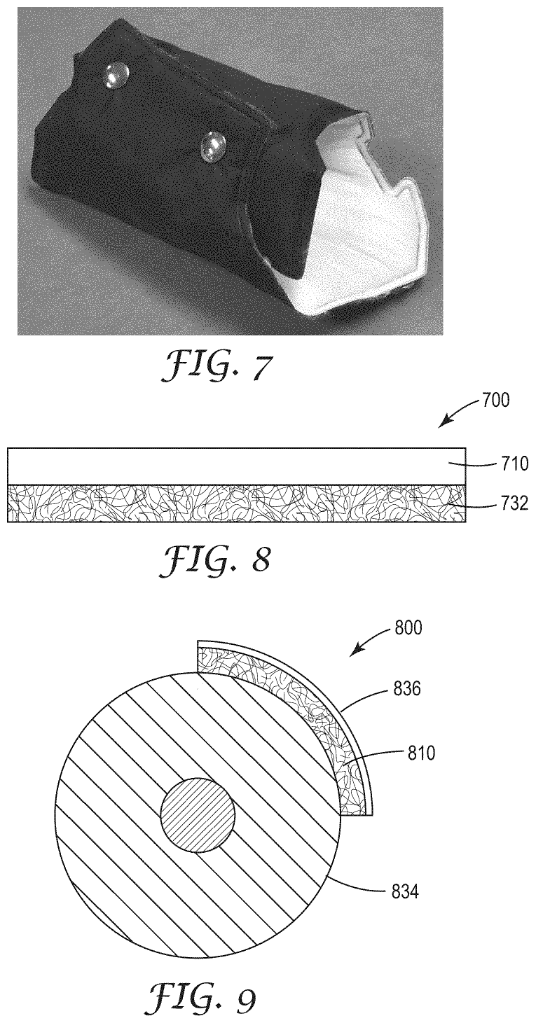

FIG. 9 shows an alternative noise-resistant motor assembly 800 having a motor enclosure 834, acoustic article 810, and outer shell 836, with the latter two components having a generally cylindrical configuration but shown here in fragmentary view. The acoustic article 810 can provided in a planar form and wrapped tightly around the motor enclosure and secured to itself by thermal or ultrasonic welding, and adhesive, or through the use of a fastener such as one or more staples, rivets, or clips. As shown, the outer shell 836 is disposed on an outer surface of the acoustic article 810.

The provided motor assembly 800 addresses a technical problem with motor assemblies, such as those used in electric vehicles. This problem derives from the need for both high sound absorption and low thermal resistance. Since conventional materials can require relatively thick layers of insulation, these also tend to result in increased thermal resistance. This can complicate thermal management since it may be desirable to transfer heat away from the motor enclosure 834 to prevent thermally-induced damage to internal motor components.

The acoustic article 810 can provide a high degree of acoustic absorption performance in a relatively thin layer. Such layers can be, for example, up to 25 millimeters, up to 20 millimeters, up to 15 millimeters, up to 12 millimeters, or up to 10 millimeters in thickness. Along with the benefits of reducing thermal resistance, use of a thin acoustic article 810 can also save space and help reduce the overall weight of the motor assembly 800.

### Acoustic Articles

The acoustic articles incorporated into the noise-resistant assemblies can be effective in addressing both noise and undesirable vibrations associated with a structure. In some embodiments, the acoustic article can be disposed on a substrate or placed proximate to an air cavity to absorb sound energy being transmitted through the substrate or air cavity, respectively. In other embodiments, the acoustic article can be placed proximate to a surface to damp vibrations of the surface.

Damping applications include nearfield damping applications. Nearfield damping is a mechanism that dissipates the vibration energy of a structure by controlling both non-propagating and propagating waves that are created near the surface (nearfield region) of the structure by structural vibration. In the nearfield region, oscillatory and incompressible fluid flows parallel to the surface of the structure, with the strength of these flows decreasing gradually with increasing distance from the surface of the vibrating structure. The strength of the energy in this region can be significant, so dissipation of the energy in this region can help attenuate structural vibration.

The nearfield region can be defined as from 30 centimeters to 0 centimeters, from 15 centimeters to 0 centimeters, from 10 centimeters to 0 centimeters, from 8 centimeters to 0 centimeters, from 5 centimeters to 0 centimeters, relative to the surface of a given substrate (or structure). Here, “0 centimeters” is defined as being at the surface of the substrate.

Further particulars concerning nearfield damping are described in Nicholas N. Kim, Seungkyu Lee, J. Stuart Bolton, Sean Hollands and Taewook Yoo, Structural damping by the use of fibrous materials, SAE Technical Paper, 2015-01-2239, 2015.

As shown in these figures, useful acoustic articles include both single-layered and multilayered constructions. Unless specifically indicated otherwise, it is to be understood that one or more additional layers or surface treatments may be present on either major surface of a given acoustic article, or between otherwise adjacent layers of the acoustic article.

The provided acoustic articles can enable higher sound absorbing performance in relatively thin layers compared with conventional acoustic materials.

An exemplary single-layered acoustic article includes a porous layer and a plurality of heterogeneous filler received in the porous layer. In an exemplary embodiment, the heterogeneous filler is dispersed in the porous layer uniformly across its entire thickness. Exemplary porous layers include fibrous non-woven layers comprised of a plurality of fibers, open-celled foams, and particulate beds. Useful porous layers are described in detail in a separate subsection below, entitled “Porous layers.”

Heterogeneous filler having desirable acoustic properties is enmeshed in the plurality of fibers of the porous layer. The heterogeneous filler can be present in an amount of from 1% to 99%, 10% to 90%, 15% to 85%, 20% to 80%, or in some embodiments, less than, equal to, or greater than 1%, 2, 3, 4, 5, 7, 10, 12, 15, 20, 25, 30, 35, 40, 45, 50, 55, 60, 65, 70, 75, 80, 85, 90, 95, 97, 98, or 99% by weight relative to the combined weight of the porous layer and heterogeneous filler.

Examples of heterogeneous filler that impart acoustical benefits include porous and/or fine fillers such as clay, diatomaceous earth, graphite, glass bubbles, porous polymeric filler, non-layered silicates, plant-based filler, and combinations thereof. A detailed account of these heterogeneous fillers is provided in a later subsection entitled “Heterogeneous fillers.”

The heterogeneous filler in the porous layer can affect the average fiber-to-fiber spacing within the non-woven fibrous structure of the porous layer. The extent to which this occurs depends, for example, on the particle size of the heterogeneous filler and the loading of the heterogeneous filler within the porous layer. The porous layer can have an average fiber-to-fiber spacing of from 0 micrometers to 1000 micrometers, from 10 micrometers to 500 micrometers, from 20 micrometers to 300 micrometers, or in some embodiments, less than, equal to, or greater than 0 micrometers, 1, 2, 3, 4, 5, 7, 10, 11, 12, 15, 17, 20, 25, 30, 35, 40, 45, 50, 60, 70, 80, 90, 100, 110, 120, 150, 170, 200, 250, 300, 350, 400, 450, 500, 600, 700, 800, 900, or 1000 micrometers.

Conversely, the heterogeneous filler within the acoustic article has an interparticle (i.e., particle-to-particle) spacing that is at least partially dependent on both its loading level as well as the structural nature of the porous layer. The heterogeneous filler can have an average interparticle spacing of from 20 micrometers to 4000 micrometers, from 50 micrometers to 2000 micrometers, from 100 micrometers to 1000 micrometers, or in some embodiments, less than, equal to, or greater than 20 micrometers, 25, 30, 35, 40, 45, 50, 60, 70, 80, 90, 100, 110, 120, 150, 170, 200, 250, 300, 350, 400, 450, 500, 600, 700, 800, 900, 1000, 1100, 1200, 1500, 1700, 2000, 2500, 3000, 3500, or 4000 micrometers.

Average fiber-to-fiber spacing, particle-to-fiber, and particle-to-particle spacing can be obtained using X-ray microtomography, a nondestructive 3D imaging technique where the contrast mechanism is the absorption of X-rays by components within the sample under examination. An X-ray source illuminates the sample and a detection system collects projected 2D X-ray images at discrete angular positions as the sample is rotated.

The collection of projected 2D images are taken through the process known as reconstruction to produce a stack of 2D slice images along the axis of sample rotation. The reconstructed 2D slice images can be examined individually, as a series of images, or be used collectively to generate a 3D volume containing the examined sample. Measurements can be made, for example, using a SKYSCAN 1172 (Bruker microCT, Kontich, Belgium) X-ray microtomography scanner at a suitable resolution (e.g., 1-3 micrometers), and X-ray source settings of 40 kV and 250 μA.

The reconstructed images can then be processed to isolate the location of the particles or particles and fibers within the scanned specimen. A greyscale threshold can allow isolation of the particles from the lower density material in the porous layer and isolation of the particles and fibers from lower density noise in the dataset. Processing can be conducted, for example, CT Analyzer software (v 1.16.4 Bruker microCT, Kontich, Belgium) to obtain average particle-to-particle, particle-to-fiber, and fiber-to-fiber spacings.

The desirable thickness of the porous layer is highly dependent on the application and thus need not be particularly restricted. The porous layer can have an overall thickness of from 1 micrometer to 10 centimeters, from 30 micrometers to 1 centimeter, from 50 micrometers to 5000 millimeters, or in some embodiments, less than, equal to, or greater than, 1 micrometer, 2, 5, 10, 20, 30, 40, 50, 100, 200, 500 micrometers, 1 millimeter, 2, 3, 4, 5, 7, 10, 20, 50, 70, or 100 millimeters.

Advantageously, the combination of the porous layer and heterogeneous filler can significantly enhance acoustical absorption at low sound frequencies, such as sound frequencies of from 50 Hz to 500 Hz while preserving acoustical absorption at higher sound frequencies exceeding 500 Hz.

In some embodiments, the addition of heterogeneous filler can substantially increase acoustical absorption of the acoustic article over sound frequencies of less than, equal to, or greater than 50 Hz, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 210, 220, 230, 240, 250, 260, 270, 280, 290, 300, 400, 500, 700, 1000, 2000, 3000, 4000, 5000, 7000, or 10,000 Hz.

### Porous Layers

The provided acoustic articles include one or more porous layers. Useful porous layers include, but are not limited to, non-woven fibrous layers, perforated films, particulate beds, and open-celled structures such as open-celled foams, fiberglass, nets, woven fabrics, and combinations thereof. Porous layers are generally permeable, enabling air or some other fluid to freely communicate between opposite sides of the layer. Such layers may also be semi-permeable (permeable along some but not all of the thickness dimension) or impermeable.

Certain non-woven fibrous layers can be effective sound absorbers even without inclusion of heterogeneous filler. For example, non-woven materials that contain a plurality of fine fibers can be very effective at attenuating high sound frequencies. In this frequency regime, the surface area of the structure can promote viscous dissipation of noise, a process whereby sound energy is converted into heat.

Non-woven layers can be made from a wide variety of materials, including organic and inorganic materials. One inorganic fibrous non-woven material is fiberglass. Fiberglass is generally made by melting silica and other minerals in a furnace and then extruding them through spinnerets that contain tiny orifices to produce streams of molten glass. Guided by the flow of hot air, these streams are cooled into fibers and deposited onto a conveyor belt, where the fibers are interlaced with each other to obtain a non-woven fiberglass layer.

Polymeric non-woven layers can be made using a melt blowing process. Melt blown non-woven fibrous layers can contain very fine fibers. In melt-blowing, one or more thermoplastic polymer streams are extruded through a die containing closely arranged orifices. These polymer streams are attenuated by convergent streams of hot air at high velocities to form fine fibers, which are then collected on a surface to provide a melt-blown non-woven fibrous layer. Depending on the operating parameters chosen, the collected fibers may be semi-continuous or essentially discontinuous.

Polymeric non-woven layers can also be made by a process known as melt spinning. In melt spinning, the non-woven fibers are extruded as filaments out of a set of orifices and allowed to cool and solidify to form fibers. The filaments are passed through an air space, which may contain streams of moving air, to assist in cooling the filaments and passing through an attenuation (i.e., drawing) unit to at least partially draw the filaments. Fibers made through a melt spinning process can be “spunbonded,” whereby a web comprising a set of melt-spun fibers are collected as a fibrous web and optionally subjected to one or more bonding operations to fuse the fibers to each other. Melt-spun fibers are generally larger in diameter than melt-blown fibers.

Polymers suitable for use in a melt blown or melt spinning process can include polyester, polyamide, polyolefin (including polyethylene and polypropylene), cyclic polyolefin, polyolefinic thermoplastic elastomers, poly(meth)acrylate, polyvinyl halide, polyacrylonitrile, polyurethane, polylactic acid, polyvinyl alcohol, polyphenylene sulfide, polysulfone, polyoxymethylene, fluid crystalline polymer, and copolymers and blends thereof.

Non-woven fibers can be made from a thermoplastic semi-crystalline polymer, such as a semi-crystalline polyester. Useful polyesters include aliphatic polyesters. Non-woven materials based on aliphatic polyester fibers can be especially advantageous in resisting degradation or shrinkage at high temperature applications. This property can be achieved by making the non-woven fibrous layer using a melt blowing process where the melt blown fibers are subjected to a controlled in-flight heat treatment operation immediately upon exit of the melt blown fibers from the multiplicity of orifices. The controlled in-flight heat treatment operation takes place at a temperature below a melting temperature of the portion of the melt blown fibers for a time sufficient to achieve stress relaxation of at least a portion of the molecules within the portion of the fibers subjected to the controlled in-flight heat treatment operation. Details of the in-flight heat treatment are described in U.S. Patent Publication No. 2016/0298266 (Zillig et al.).

Molecular weights for useful aliphatic polyesters need not be particularly restricted and can be in the range of from 15,000 g/mol to 6,000,000 g/mol, from 20,000 g/mol to 2,000,000 g/mol, from 40,000 g/mol to 1,000,000 g/mol, or in some embodiments, less than, equal to, or greater than 15,000 g/mol; 20,000; 25,000; 30,000; 35,000; 40,000; 45,000; 50,000; 60,000; 70,000; 80,000; 90,000; 100,000; 200,000; 500,000; 700,000; 1,000,000; 2,000,000; 3,000,000; 4,000,000; 5,000,000; or 6,000,000 g/mol.

The fibers of the non-woven fibrous layer can have any suitable diameter. The fibers can have a median fiber diameter of from 0.1 micrometers to 10 micrometers, from 0.3 micrometers to 6 micrometers, from 0.3 micrometers to 3 micrometers, or in some embodiments, less than, equal to, or greater than 0.1 micrometers, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 22, 25, 27, 30, 32, 35, 37, 40, 42, 45, 47, 50, 53, 55, 57, or 60 micrometers.

Optionally, at least some of the plurality of fibers in the non-woven fibrous layer are physically bonded to each other or to the heterogeneous filler. In general, this has the effect of increasing stiffness and/or strength to the acoustic article, which may be desirable in certain applications. Conventional bonding techniques include use of heat and pressure applied in a point-bonding process or by passing the non-woven fibrous layer through smooth calendar rolls. Such processes can cause deformation of fibers or compaction of the web, however, which may or may not be desirable.

As another option, attachment between fibers or between fiber and the heterogeneous filler may be achieved by incorporating a binder into the non-woven fibrous layer. In some embodiments, the binder is provided by a liquid or a solid powder. In some embodiments, the binder provided by staple binder fibers, which may be injected into the polymer stream during a melt blowing process. Binder fibers have a melting temperature significantly less than that of remaining structural fibers, and act to secure the fibers to each other.

Other methods for bonding fibers to each other are taught in, for example, U.S. Patent Publication No. 2008/0038976 (Berrigan et al.) and U.S. Pat. No. 7,279,440 (Berrigan et al.). In one technique, a collected web of fibers is exposed to a controlled heating and quenching operation that includes forcefully passing through the web a gaseous stream heated to a temperature sufficient to soften the fibers sufficiently to cause the fibers to bond together at points of fiber intersection, where the heated stream is applied for a time period too short to wholly melt the fibers, and then immediately forcefully passing through the web a gaseous stream at a temperature at least 50° C. less than the heated stream to quench the fibers.

In some embodiments, the fiber polymers have high glass transition temperatures, which can be preferred when the acoustic article is to be used in high temperature environments. Certain non-woven fibrous layers shrink significantly when heated to even moderate temperatures in subsequent processing or use, such as when used as a thermal insulation material. Such shrinkage can be problematic for some applications when the melt-blown fibers include thermoplastic polyesters or copolymers thereof, and particularly those that are semi-crystalline in nature.

In some embodiments, the provided non-woven fibrous layers have at least one densified layer adjacent to a layer that is not densified. Either or both of the densified and non-densified layers may be loaded with heterogeneous filler. A densified layer can provide a number of potential benefits. If sufficiently dense, such a layer can be disposed on the outermost surface of the acoustic article and act as a barrier to prevent particles of heterogeneous filler from escaping from the acoustic article. Densification of the non-woven layer can also enhance structural integrity, provide dimensional stability, and enable the non-woven layer to be molded into a three-dimensional shape. Advantageously, a molded acoustic article can assume a customized shape that fully utilizes the space in which it is disposed.

In some embodiments, the densified layer and adjacent non-densified layer are prepared from a monolithic non-woven fibrous layer initially having a uniform density, which is then subjected to heat and/or pressure to create a densified layer on its outermost surface. Methods of producing a densified layer on a non-woven fibrous web, along with further options and advantages, are described in co-pending International Patent Application No. PCT/CN2017/101857 (You et al.).

In some embodiments, the densified layer has a uniform distribution of polymeric fibers throughout the layer. Alternatively, the distribution of polymeric fibers can be varied across a major surface of the non-woven fibrous layer. Such a construction may be appropriate where, for example, the acoustic response is to be dependent on its location along the major surface.

The median fiber diameters of the densified and non-densified portions of the non-woven fibrous layer can be substantially preserved. The processes described above are generally capable of fusing the fibers to each other in the densified region without significant melting of the fibers. In most instances, it is preferable to avoid melting the fibers to retain the acoustic benefit that derives from the surface area within the densified layer of the non-woven fibrous layer.

Other non-woven fibrous layers that may be used in the acoustic article include recycled textile fibers, sometimes referred to as shoddy. Recycled textile fibers can be formed into a non-woven structure using an air laid process, in which a wall of air blows fibers onto a perforated collection drum having negative pressure inside the drum. The air is pulled though the drum and the fibers are collected on the outside of the drum where they are removed as a web. Because of the air turbulence, the fibers are not in any ordered orientation and thus can display strength properties that are relatively uniform in all directions.

One or more additional fiber populations can be incorporated into the non-woven fibrous layer. Differences between fiber populations can be based on, for example, composition, median fiber diameter, and/or median fiber length.

For example, a non-woven fibrous layer can include a plurality of first fibers having a median diameter of up to 10 micrometers and a plurality of second fibers having a median diameter of at least 10 micrometers. For various reasons, it can be advantageous to have fibers of different diameters. Inclusion of the thicker second fibers can improve the resiliency of the non-woven fibrous layer, crush resistance, and help preserve the overall loft of the web. The second fibers can be made from any of the polymeric materials previously described with respect to the first fibers and may be made from a melt blown or melt spun process.

In some embodiments, the second fibers are staple fibers that are interspersed with the first plurality of the fibers. These staple fibers can be provided as crimped fibers to improve the overall loftiness of the fibrous web. The staple fibers can include binder fibers, which can be made from any of the above-mentioned polymeric fibers. Structural fibers can include, but are not limited to, any of the above-mentioned polymeric fibers, as well as inorganic fibers such as ceramic fibers, glass fibers, and metal fibers; and organic fibers such as cellulosic fibers.

The first and second fibers can independently have any of the compositions, structures, and properties previously described with respect to the non-woven fibrous layers containing only a single fiber population. Additional features and benefits relating to combinations of the first and second fibers are described in U.S. Pat. No. 8,906,815 (Moore et al.).

Non-woven fibrous layers can provide numerous technical advantages, at least some of which are unexpected. One advantage derives from the surface area of the non-woven fibrous layer. Retention of surface area provided by the fibers, in combination with heterogeneous filler having a high surface area, enables even a relatively small weight (or thickness) of acoustic material to provide a high level of performance as an acoustic absorber.

These non-woven materials can also be manufactured from fiber materials that can tolerate high temperatures where conventional insulation materials would thermally degrade or fail. This is suitable for insulation materials in automotive and aerospace vehicle applications, which commonly operate in environments that are not only noisy but can reach extreme temperatures. These materials can be highly resilient, enabling them to be compressed and spring back to fill available space within a given cavity. Finally, as described above, these non-woven fibrous layers can also be shaped if so desired to fit a substrate or cavity within a given application, thereby facilitating installation by an operator.

### Heterogeneous Fillers

The acoustic articles described herein can incorporate one or more heterogeneous fillers that are capable of providing enhanced acoustic properties. Each of the heterogeneous fillers referred to in the embodiments above may independently have distinct characteristics, as described below.

Exemplary heterogeneous fillers include heterogeneous fillers that are porous and/or fine. Porous and/or fine fillers that can be incorporated into the provided acoustic articles include particles of clay, diatomaceous earth, graphite, glass bubbles, polymeric filler, non-layered silicate, plant-based filler, and mixtures thereof. Filler particles can have various shapes, including that of flakes, powders and fibers. The particles may in some cases, be primary particles that are agglomerated (i.e., aggregated) into larger particles.

Clay fillers are widely available and commonly used in rubber compounding applications to provide reinforcement and improved physical or processing properties. As used herein, clays include any of a variety of hydrous aluminosilicate minerals found in nature, and generally display a stacked sheet-like microstructure. A primary component of clays is kaolin. Kaolin, sometimes referred to as kaolinite, is characterized by alternating layers of alumina and silica. Another useful clay is bentonite, an absorbent aluminum phyllosilicate clay comprised mostly of montmorillonite. Other clays can be purely synthetic and not obtained from a natural source. One such synthetic clay is LAPONITE, which is comprised of silica layers, octahedrally coordinated magnesium, and alkali metal ions.

In some cases, clay fillers can be converted into other materials by a heating process known as calcining. Calcining temperatures can range from 800-1000° C. At these temperatures, water of hydration within the clay can be driven out. When fully calcined, the individual mineral platelets become fused together and the clays can become relatively inert.

Heterogeneous fillers may also include non-layered silicate materials. Non-layered silicates include alkali silicates, alkaline earth silicates, non-zeolitic aluminosilicates, and geopolymers. Such materials may or may not be zeolites. An example of a non-zeolitic aluminosilicate material is nepheline, which is an aluminosilicate of sodium and potassium.

Diatomaceous earth is made from the fossilized remains of tiny, aquatic organisms called diatoms. These fossilized remains are primarily composed of silica, but also include small amounts of alumina, and iron oxide. In filler form, it is a powder with a polydisperse particle size distribution, generally ranging from 10 micrometers to 200 micrometers. Optionally, diatomaceous earth can be mechanically processed by grinding or the like to reduce its median particle size. Like the clay materials above, diatomaceous earth can be calcined to remove impurities and undesirable volatile components. Chemical processing can also be employed to remove impurities.

Graphite fillers can be made from expanded graphite, unexpanded graphite, or a mixture thereof. Graphite is a crystalline allotropic form of carbon and can be obtained from natural sources or produced synthetically by heating petroleum coke to approximately 3000° C. in a furnace. Graphite is unexpanded in its naturally occurring form. It can be converted to expanded graphite by intercalating chemical compounds, such as sulfuric acid, between the sp²-hybridized carbon sheets that comprise graphite. One can then heat the graphite particles or flakes to a temperature above the exfoliation temperature of the graphite (typically between 150° C. and 300° C.) which causes the graphite layers to separate from each other and expand to several times their original thickness.

Although not necessarily graphitic, other forms of porous carbon may also be used as heterogeneous filler. Useful porous carbons include activated and vermiculite carbon fillers, which have unique acoustic properties based on their varying degrees of porosity. Details concerning these materials are described co-pending International Patent Application No. PCT/US18/56671 (Lee et al.) and its disclosure of porous carbon fillers is expressly incorporated by reference herein.

Porous polymer fillers can have a wide range of porosities, making them suitable for acoustic absorption at frequencies below 1000 Hz. These absorption properties have been observed in many polymer compositions, including polypropylene, divinylbenzene-maleic anhydride, styrene-divinylbenzene, and acrylic polymers. Porous polymer fillers include open-cell foams, closed-cell foams, and combinations thereof. Examples of fillers comprised of open-cell polymeric foams include polyolefin foam fillers available under the trade designation ACCUREL MP by Evonik Industries AG in Essen, Germany.

Fillers may, in some cases, be aggregated (i.e. agglomerated). Primary filler particles may be aggregated to each other by particle-to-particle interactions. Such interactions can derive from secondary bond forces or electrostatic forces. In some embodiments, at least some of the polymer particles are sintered together under slight pressure and heat to form agglomerates. The heat may be provided using any known method, including steam, high-frequency radiation, infrared radiation, or heated air. Aggregation of particles may also be achieved by using adhesives or binders.

Particle aggregates may be regularly or irregularly shaped. Preferably, aggregates stay together in intended use with most particles retaining their specified dimensions but are not necessarily “crushproof” In some embodiments, the pores within the acoustic article can be borne entirely from the interstitial spaces created amongst the primary filler particles.

Plant-based fillers include cellulosic fillers such as wood flour. Wood flour is composed of fine particles of wood, and generally obtained from woodworking operations such as sawing, milling, planing, routing, drilling and sanding. Other plant-based fillers include flax, jute, sisal, hemp, wheat and rice straw, rice husk, ash, starches, and lignin. Some of these fillers are fibrous in nature, offering benefits as lightweight reinforcing fillers in composite materials. Cork and waste shells from nuts contain cellulose and lignin. Plant-based fillers can be highly porous.

Other possible heterogeneous fillers can include bio-based fillers that are not plant-based. These include filler particles derived from waste streams like chicken feathers or shellfish shells. Filler may also derive from fungi, sea sponges, and other biological products outside the plant kingdom.

The heterogeneous fillers above, independently, can have any suitable median particle size. Filler particles can be sized to create interstitial voids having a desired size distribution when incorporated into a given porous layer. Such voids can represent spaces between and amongst filler particles, non-woven fibers (if present), polymeric or inorganic struts (if present), or combinations thereof. Median particle size of the filler particles is a parameter that can also be used to adjust the permeability (and overall flow resistance) of the acoustic article.

The heterogeneous filler can have a median particle size of from 1 micrometer to 1000 micrometers, from 1 micrometer to 800 micrometers, from 1 micrometer to 100 micrometers, from 100 micrometers to 1000 micrometers, from 100 micrometers to 800 micrometers, or in some embodiments, less than, equal to, or greater than 1 micrometer, 2, 3, 4, 5, 7, 10, 15, 20, 25, 30, 35, 40, 45, 50, 60, 70, 80, 90, 100, 150, 200, 250, 300, 350, 400, 450, 500, 600, 700, 800, 900, or 1000 micrometers.

The heterogeneous fillers disposed within a given porous layer can have any suitable particle size distribution to provide a desired acoustic response. The particle size distribution may be monodisperse or polydisperse. The particle size distribution may be monomodal or polymodal, independently of how many heterogeneous filler compositions are present in the porous layer. The heterogeneous filler can have a Dv50/Dv90 particle size ratio of from 0.25 to 1, 0.3 to 0.9, 0.4 to 0.8, or in some embodiments, less than, equal to, or greater than 0.25, 0.3, 0.35, 0.4, 0.45, 0.5, 0.55, 0.6, 0.65, 0.7, 0.75, 0.8, 0.85, 0.9, 0.95, or 1.

Dv50 and Dv90 can be defined by the volume-weighted size distribution as determined using laser scattering. Assuming a volume weighted distribution, Dv50 refers to the median particle diameter and Dv90 refers to the particle diameter for which 90% of the total volume of filler particles would have a smaller diameter. One can also adjust such a distribution by using testing sieving to exclude particles of certain diameters.

The heterogeneous fillers above, independently, can have any suitable specific surface area. Based on their porous nature, it is possible for the heterogeneous filler to display high surface areas. Having a high surface area can reflect a high degree of complexity and tortuosity of the pore structure, leading to greater internal reflections and energy transfer to the solid structure through frictional losses. Advantageously, this can be manifested as absorption of airborne noise.

The specific surface area of the heterogeneous filler can be from 0.1 m²/g to 10,000 m²/g, 0.1 m²/g to 100 m²/g, from 1 m²/g to 100 m²/g, from 100 m²/g to 800 m²/g, from 0.1 m²/g to 800 m²/g, or in some embodiments, less than, equal to, or greater than 0.1 m²/g, 0.2, 0.5, 0.7, 1, 2, 5, 10, 20, 50, 100, 120, 150, 200, 250, 300, 350, 400, 450, 500, 6000, 700, 800, 900, 1000, 1500, 2000, 2500, 3000, 3500, 4000, 4500, 5000, 6000, 7000, 8000, 9000, or 10,000 m²/g.

Surface area can be measured based on the sorption of either nitrogen or krypton gas at liquid nitrogen temperatures onto the surface of a given material. These measurements can be performed using an instrument known a gas sorption analyzer. In this measurement, one can generate an isotherm (volume of gas adsorbed at standard temperature and pressure per unit mass versus relative pressure) by dosing a sample with gas. Then, by applying a modified form of the Langmuir equation known as the Brunauer-Emmett-Teller (BET) equation to the isotherm, it is possible to calculate the specific surface area. This value is known as the BET specific surface area. In some embodiments, the specific surface area, as referred to herein, is the BET specific surface area.

In some embodiments, the heterogeneous filler is characterized by exceedingly fine pores. The heterogeneous filler can have an average pore size of from 0.4 nanometers to 50 micrometers, from 1 nanometer to 40 micrometers, from 2.5 nanometers to 30 micrometers, or in some embodiments, less than, equal to, or greater than 0.1 nanometers, 0.2, 0.3, 0.4, 0.5, 1, 1.2, 1.5, 1.7, 2, 3, 4, 5, 7, 10, 15, 20, 25, 30, 40, 50, 70, 100, 150, 200, 250, 300, 350, 400, 450, 500, 600, 700, 800, 900 nanometers, 1 micrometer, 2, 3, 4, 5, 7, 10, 15, 20, 25, 30, 35, 40, 45, or 50 micrometers.

Heterogeneous filler particles can have pore sizes that are far smaller than conventional fillers used in acoustic applications. For example, the smallest pores of certain polymers of intrinsic microporosity can be less than 2 nm in diameter. Calcined diatomaceous earth, in contrast, contains pores that are generally several hundred nanometers to several tens of micrometers. Generally, the heterogeneous filler can have a minimum pore size of up to 10000 nm, up to 5000 nm, up to 2000 nm, up to 1000 nm, up to 500 nm, up to 400 nm, up to 300 nm, up to 200 nm, up to 100, up to 50, up to 20, up to 10, up to 5, up to 2, and up to 1 nm.

The heterogeneous filler can have a total pore volume of from 0.01 cm³/g to 5 cm³/g. In some embodiments, the total pore volume can be less than, equal to, or greater than, 0.01 cm³/g, 0.02, 0.05, 0.07, 0.1, 0.2, 0.3, 0.4, 0.5, 0.7, 1, 1.2, 1.4, 1.6, 1.8, 2, 2.5, 3, 3.5, 4, 4.5, or 5 cm³/g.

Bonding of the heterogeneous filler to a porous layer can be facilitated by modification of the particle surfaces via silanes or other metal or metalloid complexes. Depending on the functionalities present, either inter- or intramolecular bonding to the layer can be achieved. Polymeric heterogeneous fillers (or aggregates that contain a polymeric binder) can be modified by a variety of routes, including various forms of grafting, solvent-treatment, and e-beam irradiation. These modifications can also facilitate bonding of particles to the porous layer.

### EXAMPLES

TABLE 1
Test Materials

| Material | Description | Source |
|---|---|---|
| AC | Activated carbon particles, mesh size 60 × 150 | Kuraray Chemical Co., |
| | (range of largest diameter “d”: 80 < d < 250 | LTD, Osaka, Japan |
| | micrometers), grade GWH. Surface area was | |
| | measured and found to be 1626 m²/g. | |
| EPDM | Ethylene propylene diene monomer (EPDM) | Xiamen Kingtom Rubber- |
| | rubber mat, 3.8 kg/m² | Plastic Co., Ltd, Xiamen, |
| | | China |
| HT500P | High temperature acoustic absorber available under | 3M Company, St. Paul, MN. |
| | the trade designation 3M THINSULATE HT500P | United States |

### Test Methods

### Normal Incident Acoustical Absorption

Normal incident acoustical absorption was tested according to ASTM E1050-12, “Standard Test Method for Impedance and Absorption of Acoustical Materials Using a Tube, Two Microphones and a Digital Frequency Analysis System”. An “IMPEDANCE TUBE KIT (50 HZ-6.4 KHZ) TYPE 4206” available from Brüel & Kjær (Denmark) was used. The normal incident absorption coefficient was reported, using the abbreviation “α”.

### Surface Area of the Activated Carbon

Surface area of the activated carbon material was analyzed using an AUTOSORB IQ (Quantachrome Instruments, Boynton Beach, Fla.). Surface area was determined by N₂ adsorption at 77 K.

### Transmission Loss Acoustic Testing

Transmission loss was tested by following the procedures outlined in ASTM E2611-09 (Standard Test Method for Measurement of Normal Incidence Sound Transmission of Acoustical Materials Based on the Transfer Matrix Method). The transmission coefficient, representing the acoustic energy being transmitted by the material was calculated and reported as T_{L} in dB.

### Example 1 (EX1)

A nonwoven melt blown web was prepared by a process similar to that described in Wente, Van A., “Superfine Thermoplastic Fibers” in Industrial Engineering Chemistry, Vol. 48, pages 1342 et seq. (1956), and in Report No. 4364 of the Naval Research Laboratories, published May 25, 1954 entitled “Manufacture of Superfine Organic Fibers” by Wente, Van. A. Boone, C. D., and Fluharty, E. L., except that a drilled die was used to produce the fibers.

A polypropylene resin (C700-35N obtained from Braskem of Sao Paula, Brazil) was extruded through the die into a high velocity stream of heated air which drew out and attenuated the polypropylene blown microfibers (“BMF”) prior to their solidification and collection. The stream of polypropylene blown microfibers was blended with polypropylene staple fibers according to the method described in U.S. Pat. No. 4,118,531 (Hauser). Additionally, AC activated carbon particles were fed into the stream of polypropylene blown microfibers, according to the method of U.S. Pat. No. 3,971,373 (Braun). The blend of polypropylene blown microfibers, polypropylene staple fibers, and activated carbon particles was collected in a random fashion on a nylon belt, affording the polypropylene BMF-web particle layer loaded with activated carbon particles. The BMF-web particle layer was loaded with a ratio of 25 wt. % activated carbon particles and 75 wt. % blown microfibers. A 40 gsm (grams per square meter) black scrim (obtained from Nantong Gather Excellence-Cleaning Medical Materials Co., Ltd of Jiangsu, China) was layered onto one side of the carbon containing web and a 16 gsm white scrim (obtained from Fitesa of Simpsonville, S.C. United States) was layered onto the other side of the carbon containing web. The basis weight of the sample was 900 gsm with a 12 mm thickness.

The sample underwent Normal Incident Acoustical Absorption and Transmission Loss Acoustic Testing, and the results are represented in Tables 2 and 3. Testing was performed with the scrim facing the sound source.

### Comparative Example 1 (CE1)

A 13-mm thick sample of HT500P underwent Normal Incident Acoustical Absorption, and the results are represented in Table 2.

### Comparative Example 2 (CE2)

A 2-mm thick sample of EPDM underwent Transmission Loss Acoustic Testing, and the results are represented in Table 3.

TABLE 2
Test Results

| | EX1 | CE1 |
|---|---|---|
| Frequency (Hz) | α | α |
| 80 | 0.01 | 0.02 |
| 100 | 0.02 | 0.02 |
| 125 | 0.02 | 0.02 |
| 160 | 0.02 | 0.02 |
| 200 | 0.03 | 0.03 |
| 250 | 0.04 | 0.05 |
| 315 | 0.06 | 0.06 |
| 400 | 0.13 | 0.09 |
| 500 | 0.28 | 0.13 |
| 630 | 0.50 | 0.19 |
| 800 | 0.66 | 0.28 |
| 1000 | 0.69 | 0.39 |
| 1250 | 0.67 | 0.51 |
| 1600 | 0.63 | 0.63 |
| 2000 | 0.60 | 0.76 |
| 2500 | 0.59 | 0.87 |
| 3150 | 0.59 | 0.91 |
| 4000 | 0.62 | 0.91 |
| 5000 | 0.65 | 0.88 |
| 6300 | 0.68 | 0.83 |

TABLE 3
Test Results

| | EX1 | CE2 |
|---|---|---|
| Frequency (Hz) | T_{L} (dB) | T_{L} (dB) |
| 160 | 9.2 | 6.7 |
| 200 | 6.2 | 9.8 |
| 250 | 6.8 | 12.9 |
| 315 | 10.9 | 15.6 |
| 400 | 12.5 | 18.2 |
| 500 | 11.6 | 22.2 |
| 630 | 11.4 | 23.5 |
| 800 | 11.3 | 27.4 |
| 1000 | 12.1 | 32.3 |
| 1250 | 13.0 | 35.6 |
| 1600 | 13.8 | 33.7 |
| 2000 | 15.2 | 31.0 |
| 2500 | 17.1 | 31.0 |
| 3150 | 19.0 | 36.6 |

### Prophetic Example 1

A sample as described in Example 1 will be wrapped around a motor enclosure and be coupled to itself by a mechanical rivet-based fastener.

### Prophetic Example 2

A sample as described in Example 1 will be ultrasonically welded onto the inner surface of an outer wall of a pool housing.

### Prophetic Example 3

A sample as described in Example 1 will be overlaid and attached using a pressure sensitive adhesive onto the surface of a duct assembly in a vehicle.

### Prophetic Example 4

A sample as described in Example 1 will be overlaid and attached using a pressure sensitive adhesive onto a carpet layer surface of a vehicle.

### Prophetic Example 5

A sample as described in Example 1 will be thermally welded onto a surface of a sliding track of a roof panel in a vehicle.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

What is claimed is:

1. A noise-resistant assembly comprising:
a tubular body having an inner surface; and
an acoustic article coupled to the inner surface, the acoustic article comprising a porous layer and a heterogeneous filler having a median particle size of from 1 micrometer to 1000 micrometers and a specific surface area of from 0.1 m²/g to 10,000 m²/g received in the porous layer.

2. The noise-resistant assembly of claim 1, wherein the inner surface of the tubular body includes a cavity and the acoustic article is at least partially received in the cavity.

3. The noise-resistant assembly of claim 2, further comprising a cover layer extending across an opening of the cavity to secure the acoustic article within the cavity.

4. A noise-resistant assembly comprising:
a motor; and
an acoustic article that at least partially encloses the motor, the acoustic article comprising a porous layer and a heterogeneous filler having a median particle size of from 1 micrometer to 1000 micrometers and a specific surface area of from 0.1 m²/g to 10,000 m²/g received in the porous layer.

5. The noise-resistant assembly of claim 4, wherein the acoustic article is coupled to itself to provide an enclosure, the motor being at least partially received in the enclosure.

6. The noise-resistant assembly of claim 4, further comprising an outer shell disposed on an outer surface of the acoustic article.

7. A noise-resistant assembly comprising:
carpet layer; and
acoustic article extending across the carpet layer, the acoustic article comprising a porous layer and a heterogeneous filler having a median particle size of from 1 micrometer to 1000 micrometers and a specific surface area of from 0.1 m²/g to 10,000 m²/g received in the porous layer.

8. The noise-resistant assembly of claim 7, wherein the porous layer comprises a fibrous non-woven layer.

9. The noise-resistant assembly of claim 7, wherein the heterogeneous filler comprises porous carbon.

10. The noise-resistant assembly of claim 7, wherein the heterogeneous filler comprises diatomaceous earth, plant-based filler, unexpanded graphite, polyolefin foam, or a combination thereof, having a median particle size of from 1 micrometer to 1000 micrometers, and a specific surface area of from 0.1 m²/g to 800 m²/g.
